(19) United States
(12) Patent Application Publication
(10) Pub. No.: US 2009/0027702 A1
(43) Pub. Date: Jan. 29, 2009

(54) IMAGE FORMING APPARATUS

(75) Inventor: Takaaki Sakai, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 11/953,112

(22) Filed: Dec. 10, 2007

(30) Foreign Application Priority Data
Jan. 29, 2007 (JP) JP2007-017838

(51) Int. Cl. G06F 15/00; G06F 3/12

(52) U.S. Cl. 358/1.9; 358/1.15

(57) ABSTRACT

Disclosed is an image forming apparatus in which a visualized background pattern image data in which a latent image is visualized is generated, the generated visualized background pattern image data and an image data of a job are synthesized to generate a visualized background pattern synthesizing image data, and a visualized background pattern synthesizing image in which the latent image is visualized is formed based on the generated visualized background pattern synthesizing image data, to output the visualized background pattern synthesizing image on a printing sheet, at the time of a confirmation printing. Thus, a user can easily confirm the state of an invisible background pattern synthesizing image after reproduction with eyes, before the outputting of the set number of copies to be output.

### BACKGROUND OF THE INVENTION

1. Field of the Invention

The present invention relates to an image forming apparatus to synthesize a background pattern image data including a latent image with an input image data to form a background pattern synthesizing image on a printing sheet.

2. Description of Related Art

There has conventionally been known an apparatus for synthesizing an image of a printing object with a background pattern image including a latent image expressing a reproduction checking term, such as a term of “reproduction,” which is visualized at the time of reproduction, to perform the printing outputting of the synthesized image in order to prohibit or check the reproduction of a printed matter.

For example, a printing control apparatus that can edit a latent image and has a function of displaying a preview screen for confirming a background pattern image including the latent image before printing is proposed (see, for example, Japanese Patent Application Laid-Open Publication No. 2005-115874).

Now, it has recently been performed to output several hundreds or several thousands of copies of a document composed of several hundreds of sheets by using an image forming apparatus, such as a digital copier or a printer, as a mass printing machine for printing on demand (POD). In such a case, it is necessary to confirm the finished state of the printed matter in advance in order to prevent re-printing of the mass printing. In the case of performing background pattern printing by synthesizing the image of a printing object with a background pattern image to perform printing outputting, it is necessary to previously confirm that the content, the color, and the arrangement of the latent image which is visualized after the reproduction of the printed matter, are proper in consideration of including the relation with the image of the printing object together with the printing result of the background pattern synthesizing image in which the background pattern image is synthesized.

However, the preview screen of the Japanese Patent Application Laid-Open Publication No. 2005-115874 is simple, and the sizes, colors, and positions displayed on the preview screen are different from the ones actually formed on a printing sheet. Consequently, it is impossible to confirm their details. Moreover, the preview screen of the Japanese Patent Application Laid-Open Publication No. 2005-115874 is the one for previously confirming the contents of the background pattern image, and the state after the reproduction of the background pattern synthesizing image cannot be confirmed. Consequently, it is impossible to confirm that the contents, colors, arrangements, and the like, which are visualized after the reproduction of the background pattern synthesizing image, are proper in consideration of including the relation with the image of the printing object. Moreover, in the conventional configuration for confirming the contents of a background pattern with the preview screen, the previous confirmation of a latent image which is visualized after reproduction, and the previous confirmation of the output result of a printed matter are separate operations, and the previous confirmation operations are troublesome.

### SUMMARY OF THE INVENTION

It is an object of the present invention to enable a user to easily confirm the state of a background pattern synthesizing image after reproduction, before the outputting of the set number of copies to be output.

To achieve the above object, according to one aspect of the present invention, an image forming apparatus for forming an image on a printing sheet, comprises:

a printer section for forming the image on the printing sheet; and

a control section for generating a background pattern synthesizing image data by synthesizing a background pattern image data and an image data of each page of a job, and for controlling the printer section to form a background pattern synthesizing image based on the background pattern synthesizing image data, wherein

the control section generates a visualized background pattern image data based on the background pattern image data, synthesizes the generated visualized background pattern image data and at least one of the image data of the job to generate a visualized background pattern synthesizing image data, and forms a visualized background pattern synthesizing image in which a background pattern is visualized, in the printer section based on the visualized background pattern synthesizing image data.

According to the present invention, the user can easily confirm the state of an invisible background pattern synthesizing image after reproduction with eyes, before the outputting of the set number of copies to be output.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a block diagram showing a functional configuration of an image forming apparatus of an embodiment of the present invention;

FIG. 2A is a view showing an example of a background pattern image;

FIG. 2B is an enlarged view of a part of the background pattern image shown in FIG. 2A;

FIG. 2C is a view showing an image in which dots of a background image P1 of the background pattern image shown in FIG. 2A are erased and a latent image P2 is visualized by reproduction;

FIG. 3 is a view showing an example of a basic screen displayed on an LCD shown in FIG. 1;

FIG. 4A is a view showing an example of a stamp setting screen;

FIG. 4B is a view showing an example of a background pattern type selecting screen;

FIG. 4C is a view showing a typical stamp setting screen;

FIG. 5A is a view showing an example of a detail setting screen;

FIG. 5B is a view showing an example of a color setting screen;

FIG. 5C is a view showing an example of a pattern size setting screen;

FIG. 6 is a view showing the configuration of the principal part of a printer shown in FIG. 1;

FIG. 7 is a flow chart showing a printing control processing executed by a control section of FIG. 1;

FIG. 8A is a view showing an output example of a normal print output in the following case: the setting of background pattern printing is performed; the number of copies to be output is set to one; and the printing processing of a job is performed by depressing a start button;

FIG. 8B is a view showing an output example of a confirmation printing output in the following case: the setting of background pattern printing is performed; and the instruction button of a confirmation printing is depressed to perform printing processing;

FIG. 9 is a view showing an example of a “confirmation printing visualization selection” button displayed on the typical stamp setting screen;

FIG. 10 is a flow chart showing visualized background pattern image data generating processing which is executed by a control section of FIG. 1;

FIG. 11 is a flow chart showing the visualized background pattern image data generating processing which is executed by the control section of FIG. 1; and

FIG. 12 is a view showing an output example of the confirmation printing output in the following case of a second embodiment: the setting of background pattern printing is performed; and the instruction button of confirmation printing is depressed to perform printing processing.

### DETAILED DESCRIPTION OF THE PREFERRED EMBODIMENTS

### First Embodiment

The configuration of a first embodiment is first described.

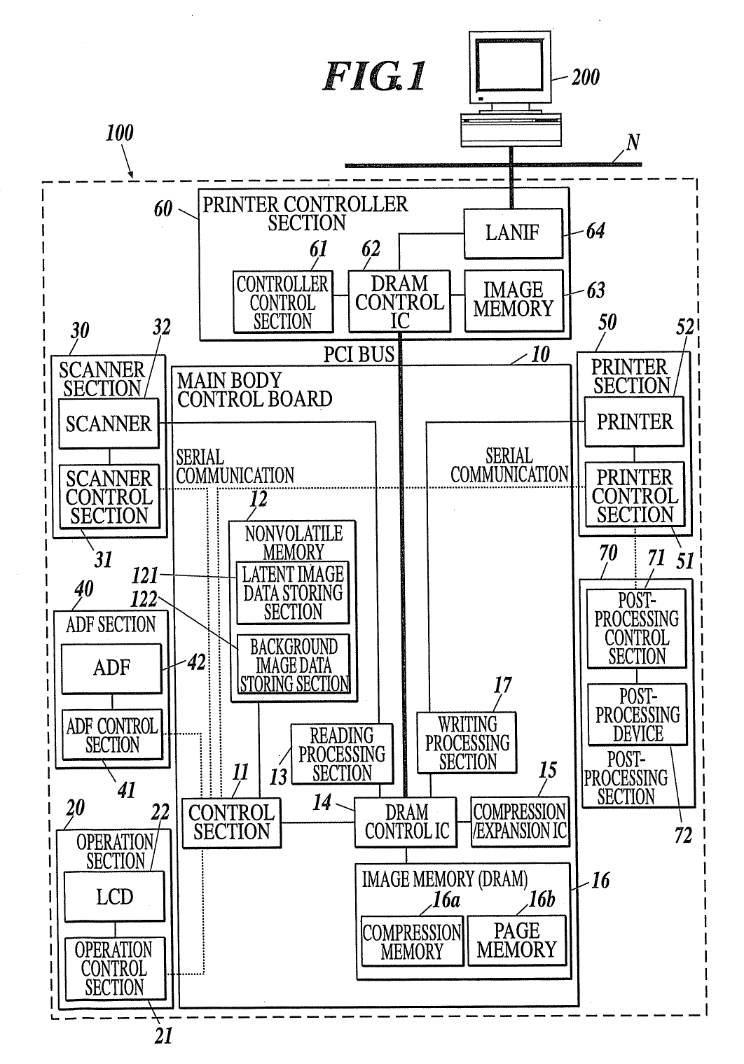

FIG. 1 shows an example of the functional configuration of an image forming apparatus 100 according to the present invention. As shown in FIG. 1, the image forming apparatus 100 comprises a main body control board 10, an operation section 20, a scanner section 30, an auto document feeder (ADF) section 40, a printer section 50, a printing controller section 60, and a post-processing section 70.

The main body control board 10 comprises a control section 11, a nonvolatile memory 12, a reading processing section 13, a dynamic random access memory (DRAM) control IC 14, a compression/expansion IC 15, an image memory (DRAM) 16, a writing processing section 17, and the like.

The control section 11 comprises a central processing unit (CPU), a read only memory (ROM), a random access memory (RAM), and the like.

The CPU of the control section 11 reads various processing programs such as a printing control processing program stored in the ROM, and expands the read processing programs in the RAM. The CPU performs the integrated control of the operation of each section of the image forming apparatus 100 in accordance with the expanded programs, and executes various kinds of processing such as printing control processing, which will be described later, and the like.

The RAM of the control section 11 works as a temporary storage region of a program read from the ROM, various kinds of data such as image data, parameters, and the like, in various kinds of processing that are executed and controlled by the control section 11. For example, the RAM of the control section 11 stores the set information of a job input through the operation screen of the operation section 20, or the set information of a job input from a host computer 200 through the printing controller section 60 in accordance with an instruction from the CPU. A job comprises a series of pages of image data and set information. The set information of a job is the information defining the contents of the processing pertaining to a printing operation to be performed based on the image data of a series of pages to be input. As the set information of a job, there can be cited, for example, the number of copies to be output (1-n), a printing mode (one side/both sides), a printing sheet size (A4/B4/A3/ . . . ), background pattern printing information (perform/not perform), detailed information (background pattern type information (registered stamp/data and time/typical stamp/serial number) to be used for a background pattern) in the case of performing background pattern printing, stamp information (reproduction/copying/invalid/ . . . ) of a typical stamp in the case where the typical stamp is include in background pattern type information, the background pattern color information (black/cyan/magenta), the background pattern pattern size information (small/normal/large), the background pattern arrangement pattern information (the angle of a latent image, the arrangement interval of latent images, the arrangement order of a plurality of background patterns in the case of the existence of a plurality of types of background patterns), and the like.

The nonvolatile memory 12 includes a latent image data storing section 121 to store latent image data, and a background image data storing section 122 to store background image data.

A background pattern image is described here.

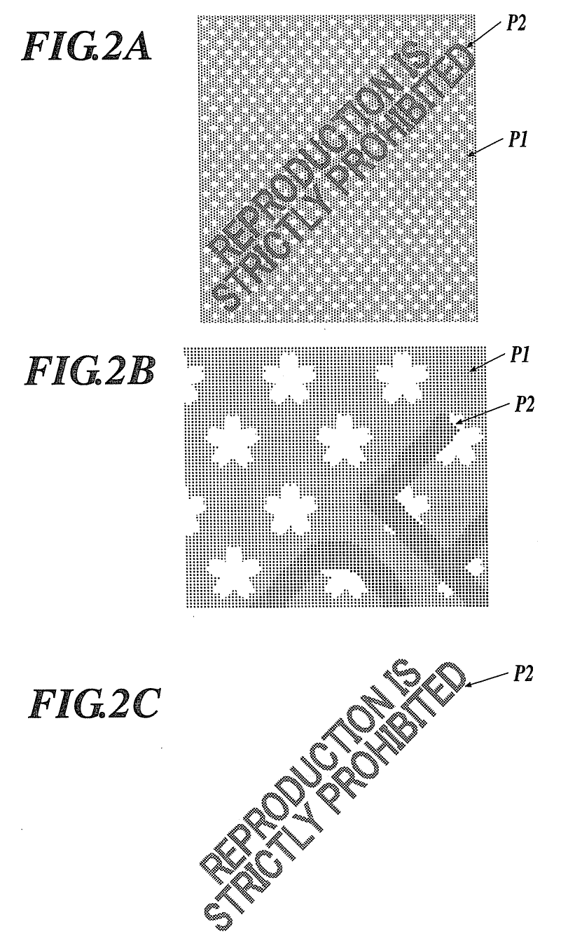

FIG. 2A shows an example of the background pattern image. As shown in FIG. 2A, the background pattern image includes a latent image P2 and a background image P1. The latent image P2 is an image including a character string, such as “reproduction is strictly prohibited” and “copying,” which is visualized by reproduction. The background image P1 is an image including a pattern having the same density as that of the latent image P2 in order to make it difficult to see the latent image P2. FIG. 2B shows a partially enlarged view of FIG. 2A. As shown in FIG. 2B, the latent image P2 is composed of dots larger than those of the background image P1. The dots of the background image P1 that are equal to or less than a reading limit in reproduction are thereby erased, and only the latent image P2 is reproduced. Then, the background pattern image becomes an image in which the latent image P2 is visualized (see FIG. 2C).

The latent image data is the image data for forming a character string and characters (figure, alphabet) that compose the latent image P2. The latent image data storing section 121 stores the latent image data of each size of large, middle, and small sizes as to each of the character strings and characters (figure, alphabet) composing the latent image P2. The latent image data includes an image portion that is the data for forming the latent image P2 and a non-image portion that is the data for forming no images around the image section (for example, the data having the density of zero).

The background image data is the image data for forming the background image P1. The background pattern image data can be generated by synthesizing the latent image data and the background image data. The background image data storing section 122 stores the background image data of the size corresponding to each printing sheet size (A4, B4, A5 . . . ) that can be used by the image forming apparatus 100.

The reading processing section 13 converts an analog image signal read by the scanner section 30 into the image data of red (R), green (G), and blue (B), and performs the conversion of image data from luminance linear to density linear, the conversion of image data from R, G, B image data into yellow (Y), magenta (M), cyan (C), black (K) image data, and the like. Moreover, in the present embodiment, the reading processing section 13 converts each image data of Y, M, C, K into the image data expressed by one bit per one pixel by performing averaging processing or the like, and outputs the converted image data to the DRAM control IC 14. Incidentally, in the present embodiment, the image data of one bit per one pixel is expressed by setting 1 to the pixel at which an image is formed and by setting 0 to the pixel at which no image is formed.

The DRAM control IC 14 makes the compression/expansion IC 15 compress the image data of a job of Y, M, C, K input from the reading processing section 13 or the image data of a job of Y, M, C, K input from the printing controller section 60 based on the control by the control section 11. The DRAM control IC 14 writes each compressed image data of Y, M, C, K into a compression memory 16a which is independently provided to each color, to temporarily store the image data. Moreover, when the DRAM control IC 14 receives an instruction of image data outputting from the control section 11, the DRAM control IC 14 makes the compression/expansion IC 15 expand each image data of Y, M, C, K which is stored in the compression memory 16a and is instructed to be output, and makes a page memory 16b which is independently provided to each color, store the expanded image data of Y, M, C, K. Then, the DRAM control IC 14 reads the image data stored in the page memory 16b to output the read image data to the writing processing section 17 in accordance with an instruction from the control section 11. Moreover, the DRAM control IC 14 outputs the set information of a job input from the DRAM control IC 14 to the control section 11. The control section 11 stores the set information of a job input from the DRAM control IC 14 into the nonvolatile memory 12.

The compression/expansion IC 15 is an integrated circuit (IC) to perform the compression processing and the expansion processing of image data by the control of the DRAM control IC 14.

The image memory 16 comprises a DRAM, and includes the compression memory 16a and the page memory 16b. The compression memory 16a temporarily stores the image data compressed by the compression/expansion IC 15 under the control of the DRAM control IC 14. The page memory 16b temporarily stores the image data expanded by the compression/expansion IC 15. The compression memory 16a and the page memory 16b are severally provided as individual four systems to each of the colors Y, M, C, K.

The writing processing section 17 generates a pulse width modulation (PWM) signal based on each image data of Y, M, C, K input from the compression/expansion IC 15, and outputs the generated PWM signal to the printer section 50.

The operation section 20 comprises an operation control section 21 and a liquid crystal display (LCD) 22.

The operation control section 21 receives a display signal from the control section 11, and performs the display control of the LCD 22. Moreover, the operation control section 21 outputs an operation signal input from the touch panel on the LCD 22 to the control section 11.

The LCD 22 performs the display of various operation screens for setting the set information of a job on a screen in accordance with an instruction of a display signal input from the operation control section 21, the display of the state of an image, the display of the operation situation of each function, and the like. A pressure sensitive (resistance film pressure) type touch panel, in which transparent electrodes are arranged in a grid, is formed on the screen of the LCD 22. The touch panel detects the X-Y coordinates of a power point depressed with a finger, a touch pen, or the like as voltage values, and outputs the detected positional signals to the operation control section 21 as operation signals.

The operation section 20 further comprises various operation buttons, such as a numeric button group 20a, an instruction button 20b for instructing the output of confirmation printing (confirmation output) as an instruction section, and a start button 20c for instructing a start of a printing operation for a set number of copies to be output. The operation section 20 then outputs an operation signal by an operation of these buttons from the operation control section 21 to the control section 11. The confirmation printing is the printing of the first page or a part of a job that is output before the start of the printing operation of the set number of copies to be output so that, for example, the finished state of an image to be formed on a printing sheet in a printer 52 can be confirmed.

In the present embodiment, the operation section 20 displays an operation screen pertaining to the setting of background pattern printing on the LCD 22, when performing image formation by synthesizing background pattern image data with the image data read by the scanner section 30, or the image data transmitted from the host computer 200 through the printing controller section 60, namely when performing the background pattern printing.

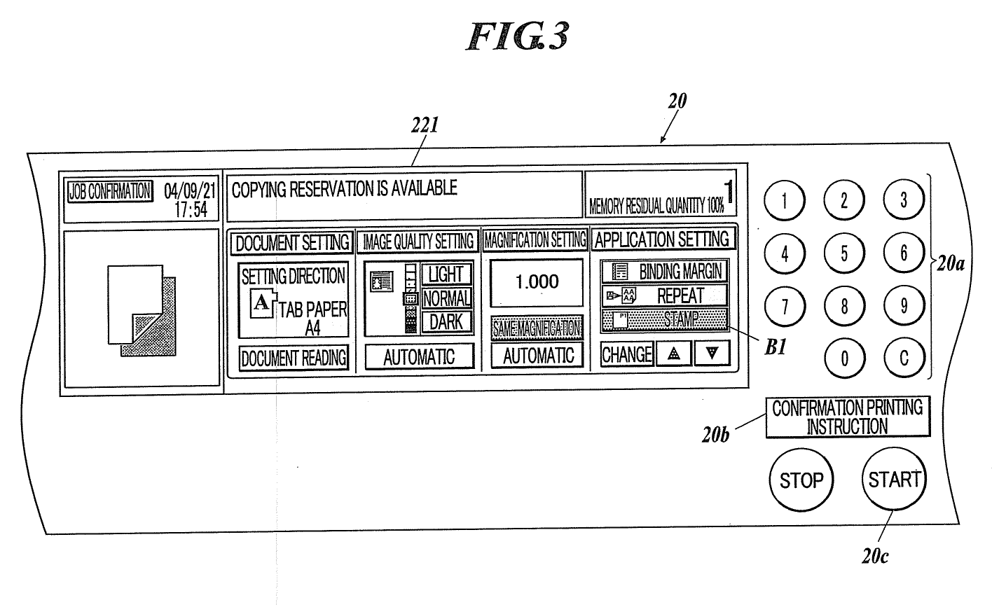

FIGS. 3-5C show a series of screens to be displayed on the LCD 22 for performing the setting pertaining to background pattern printing.

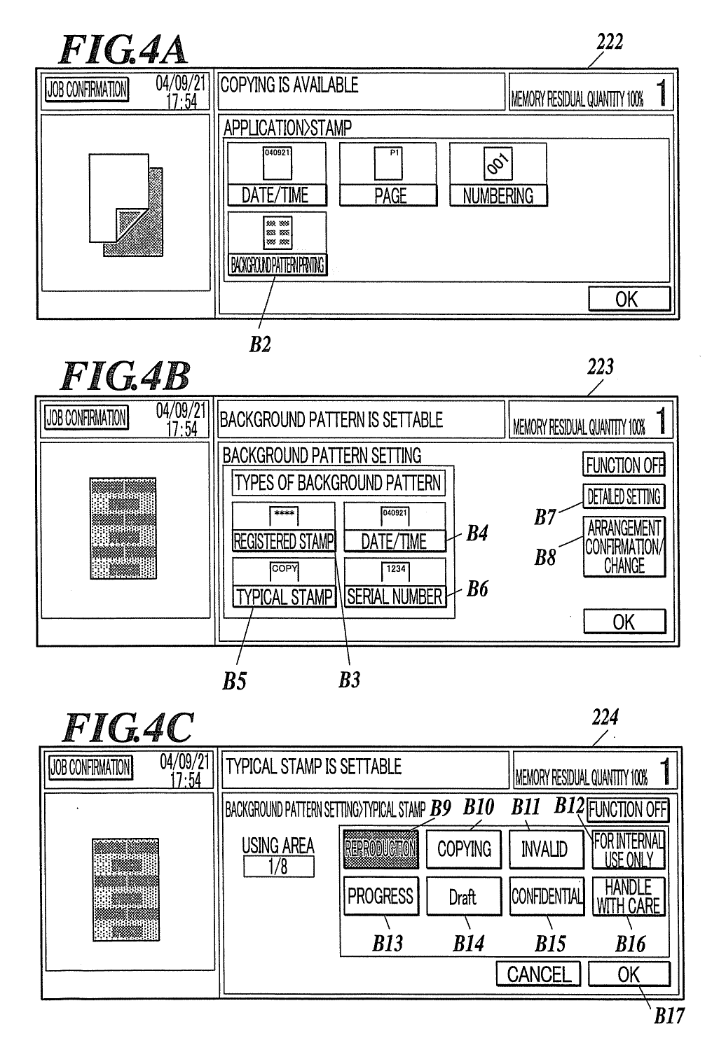

FIG. 3 is a view showing an example of a basic screen 221 to be displayed on the LCD 22. The basic screen 221 is the highest rank screen to be displayed on the LCD 22. When a “stamp” button B1 is depressed in the basic screen 221, a stamp setting screen 222 shown in FIG. 4A is displayed. When a “background pattern printing” button B2 is depressed in the stamp setting screen 222, the control section 11 sets therein the information indicating the execution of background pattern printing as the background pattern printing information of the set information of a job, and a background pattern type selecting screen 223 shown in FIG. 4B is displayed.

The background pattern type selecting screen 223 displays a “registered stamp” button B3 for selecting the “registered stamp” as the type of the background pattern, a “date/time” button B4 for selecting “date/time,” a “typical stamp” button B5 for selecting a “typical stamp,” and a “serial number” button B6 for selecting a “serial number,” as shown in FIG. 4B. The background pattern type indicates the type of the character string included in a background pattern image as a latent image. When any of the operation buttons B3-B6 is depressed in the background pattern type selecting screen 223, the control section 11 sets therein the background pattern type corresponding to the depressed button as the background pattern type information of the set information of a job, and a setting screen for setting the details of the latent image of the background pattern type is displayed.

FIG. 4C shows an example of a typical stamp setting screen 224 to be displayed when the “typical stamp” button B5 is depressed. As shown in FIG. 4C, the typical stamp setting screen 224 displays therein the contents of character strings capable of being written as the latent image data, such as “reproduction,” “copying,” and “invalid,” and displays therein stamp selecting buttons B9-B16 for instructing to write the displayed character strings as the latent image data. When any of the stamp selecting buttons B9-B16 is depressed, the control section 11 sets the typical stamp corresponding to the depressed button as the stamp information of the set information of a job. When the input from each setting screen has ended and an [OK] button B17 is depressed, the display of the screen returns to the background pattern type selecting screen 223. In the background pattern type selecting screen 223, the other background pattern type can be selected again. That is, a plurality of background pattern types can be selected. Moreover, the background pattern type selecting screen 223 displays therein a “detailed setting” button B7 and an “arrangement confirmation/change” button B8. By depressing the “detailed setting” button B7, a detail setting screen 225 for performing the detailed setting of the color, the density, the pattern size, and the like of a background pattern image is displayed. By depressing the “arrangement confirmation/change” button B8, an arrangement pattern setting screen (not-shown) for performing the confirmation and the change of the arrangement pattern of latent image data is displayed.

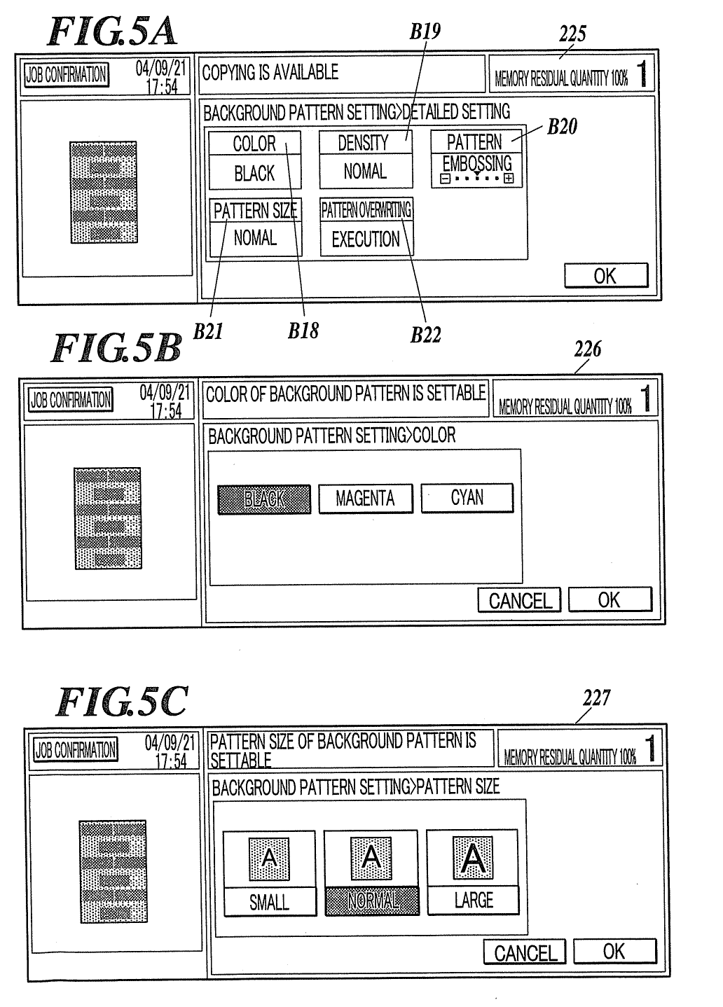

FIG. 5A shows an example of the detail setting screen 225. As shown in FIG. 5A, the detail setting screen 225 displays therein the operation buttons, such as a “color” button B18, a “density” button B19, a “pattern” button B20, a “pattern size” button B21, and a “pattern overwriting” button B22, which show the items for performing detailed setting. When any of the operation buttons is depressed, a screen for performing the detailed setting of the corresponding item is displayed. For example, when the “color” button is depressed, a color setting screen 226 shown in FIG. 5B is displayed. When the “pattern size” button is depressed, a pattern size setting screen 227 shown in FIG. 5C is displayed. The content input for setting in each displayed screen, such as the color setting screen 226 and the pattern size setting screen 227, is set as each piece of information of the set information of a job by the control section 11.

Incidentally, in the case of a printer job for forming an image by transmitting a job from the host computer 200, the set information of the job can be input from an image forming condition setting screen (not shown) to be displayed on the LCD of the host computer 200. When the host computer 200 receives the input of the following information through the input section thereof in accordance with the display on the image forming condition setting screen: the information of the number of copies to be output, printing mode information, printing sheet size information, the background pattern printing information, the detailed information in the case of executing background pattern printing, the instruction information of confirmation printing or the printing for the number of copies to be output, and the like, then the host computer 200 adds the input information to the job as the set information, and transmits the information to the image forming apparatus 100 through a communication control section. The transmitted information is set by the control section 11 as the set information of the job.

Returning to FIG. 1, the scanner section 30 comprises a scanner control section 31 and a scanner 32.

The scanner control section 31 receives a control signal from the control section 11 to perform the drive control of each section of the scanner 32. The scanner 32 includes a platen glass, a charge coupled device (CCD), and a light source. The scanner 32 reads an image on a document as an R, G, B signal by performing the image formation of a reflected light of the light that has been radiated from the light source to the document and has scanned the document, and by performing the photoelectric conversion of the reflected light by the CCD. The scanner 32 then outputs the read analog image signal to the reading processing section 13.

The ADF section 40 includes an ADF control section 41 to control an ADF 42 based on a control signal input from the control section 11, and the ADF 42. The ADF section 40 performs the automatic feeding of the documents placed on a document tray of the ADF 42 one by one onto the platen glass of the scanner 32.

The printer section 50 comprises a printer control section 51 and the printer 52.

The printer control section 51 controls the operation of each section of the printer 52 based on a control signal input from the control section 11. Moreover, the printer control section 51 is connected to the post-processing control section 71 of the post-processing section 70, and performs the relay of data communication between the control section 11 and the post-processing control section 71.

The printer 52 forms an image on a printing sheet based on the image data input from the image memory 16 by an electrophotographic process.

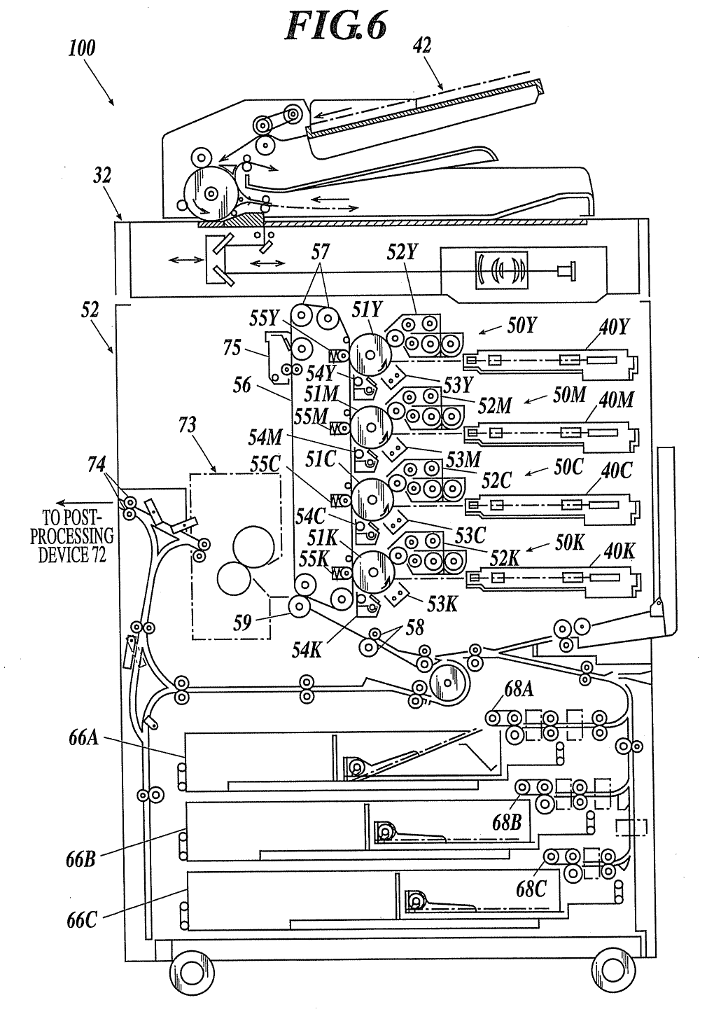

FIG. 6 shows the configuration of the principal part of the printer 52. As shown in FIG. 6, the printer 52 comprises writing units 40Y, 40M, 40C, and 40K to write latent images on photosensitive drums 51Y, 51M, 51C, and 51K, respectively, by exposing a laser thereon based on a PWM signal input by the writing processing section 17; image forming units 50Y, 50M, 50C, and 50K to form toner images of respective colors Y, M, C, and K; an intermediate transfer belt 56 as an intermediate transfer body on which the toner images formed by the image forming units 50Y, 50M, 50C, and 50K are temporarily transferred; resist rollers 58 to convey a printing sheet to secondary transfer rollers 59 in synchronization with a toner image formed on the intermediate transfer belt 56; secondary transfer rollers 59 to perform the secondary transfer of the toner image formed on the intermediate transfer belt 56 onto a printing sheet; a fixing unit 73 to fix the toner image on the printing sheet; and paper ejecting rollers 74 to eject the printing sheet.

The image forming unit 50Y comprises the photosensitive drum 51Y, a developing device 52Y, a charging device 53Y, a cleaner 54Y, and a primary transfer roller 55Y. The configurations of the image forming units 50M, 50C, and 50K are similar to that of the image forming unit 50Y.

A printing operation of the printer 52 is described here. First, in the image forming unit 50Y, the photosensitive drum 51Y rotates, and the surface thereof is charged by the charging device 53Y. The latent image of the image of Y data is formed at the charged portion by the exposure of the laser light source of the writing unit 40Y. The latent image portion is developed by the developing device 52Y, and a toner image of yellow is formed. The toner image is primarily transferred to the intermediate transfer belt 56 by the pressurized contact of the primary transfer roller 55Y. The toner image becomes a yellow image corresponding to the image data to be output. The toner that has not been primarily transferred is removed by the cleaner 54Y.

As for the image forming units 50M, 50C, and 50K, a magenta toner image, a cyan toner image, a black toner image are similarly formed and transferred, respectively. By the rotation of rollers 57, the primary transfer rollers 55Y, 55M, 55C, and 55K, and the secondary transfer rollers 59, the intermediate transfer belt 56 is also rotated, the toner images of Y, M, C, and K are superposed on the intermediate transfer belt 56 in order to be transferred thereto. Moreover, printing sheets are conveyed from any one of paper feed trays 66A-66C by the rotation of paper feed rollers 68A-68C one by one, and are conveyed to the secondary transfer rollers 59 by the rotation of the resist rollers 58.

When a printing sheet passes through the pressurized contact portion of the secondary transfer rollers 59, the toner images Y, M, C, and K on the intermediate transfer belt 56 are secondarily transferred to the printing sheet. The printing sheet, on which the toner images Y, M, C, and K are transferred, passes through the fixing unit 73. By the pressurization and the heating of the fixing unit 73, the toner images of Y, M, C, and K are fixed on the printing sheet, and a color toner image is formed. The printing sheet, on which the image is formed, is ejected to a post-processing device 72 by the paper ejecting rollers 74.

After the image formation on the printing sheet, the toner remaining on the intermediate transfer belt 56 is removed by a belt cleaner 75. Moreover, the toner remaining on the secondary transfer rollers 59 is re-transferred to the intermediate transfer belt 56, and the cleaning of the secondary transfer rollers 59 is performed, by flowing a current having a plus polarity and a current having a minus polarity from a power source 67 to the secondary transfer rollers 59 for a predetermined time in a manner of switching the currents alternately.

Each section of the aforesaid printer 52 is driven by not-shown various motors under the control of the printer control section 51 by the instructions of the control section 11.

The printing controller section 60 comprises a controller control section 61, a DRAM control IC 62, an image memory 63, a local area network (LAN) interface (IF) 64.

The controller control section 61 wholly controls the operation of each section of the printing controller section 60. Moreover, the controller control section 61 converts the image data of the job input from the host computer 200 through the LAN IF 64 into Y, M, C, K image data of a data format capable of being formed as an image by the image forming apparatus 100 in accordance with a predetermined page description language. The controller control section 61 outputs the converted image data to the DRAM control IC 62 together with the set information input from the host computer 200. In the present embodiment, the controller control section 61 converts the image data of the job input from the host computer 200 into the Y, M, C, and K image data of the format of one bit per one pixel.

The DRAM control IC 62 performs the control of temporarily storing the set information of the image data and the job that have been received by the LAN IF 64 into the image memory 63 in accordance with the instruction from the controller control section 61. Moreover, the DRAM control IC 62 is connected to the DRAM control IC 14 through a peripheral components interconnect (PCI) bus, and reads the set information of image data and a job from the image memory 63 in accordance with an instruction from the controller control section 61 to output the read set information to the DRAM control IC 14.

The image memory 63 comprises a DRAM, and temporarily stores input data.

The LAN IF 64 is a communication interface for the connection to a communication network N, such as a LAN, and is a network interface card (NIC), a modem, and the like. The LAN IF 64 performs the transmission and the reception of data, such as image data, with the host computer 200. The image data received from the host computer 200 is output to the DRAM control IC 62.

The post-processing section 70 comprises the post-processing control section 71 and the post-processing device 72. The post-processing control section 71 performs the control of each section of the post-processing device 72 based on a control signal input from the control section 11 through the printer control section 51. The post-processing device 72 performs the punching processing, the sorting processing, the binding processing, and the like of a printing sheet, on which an image has been formed, conveyed from the printer 52 based on a control signal from the post-processing control section 71.

The host computer 200 is a terminal apparatus, such as a personal computer (PC), which comprises an input section composed of a keyboard, a mouse, and the like; a display section composed of an LCD and the like; a communication control section for connecting the host computer 200 to the communication network N; a storage section storing image data; and the like. When an image, image formation condition setting, and the like, are input through the input section, the host computer 200 adds the set condition to the image data as the set information of the job, and transmits the set condition to the image forming apparatus 100 through the communication control section.

Next, the operation of the first embodiment is described.

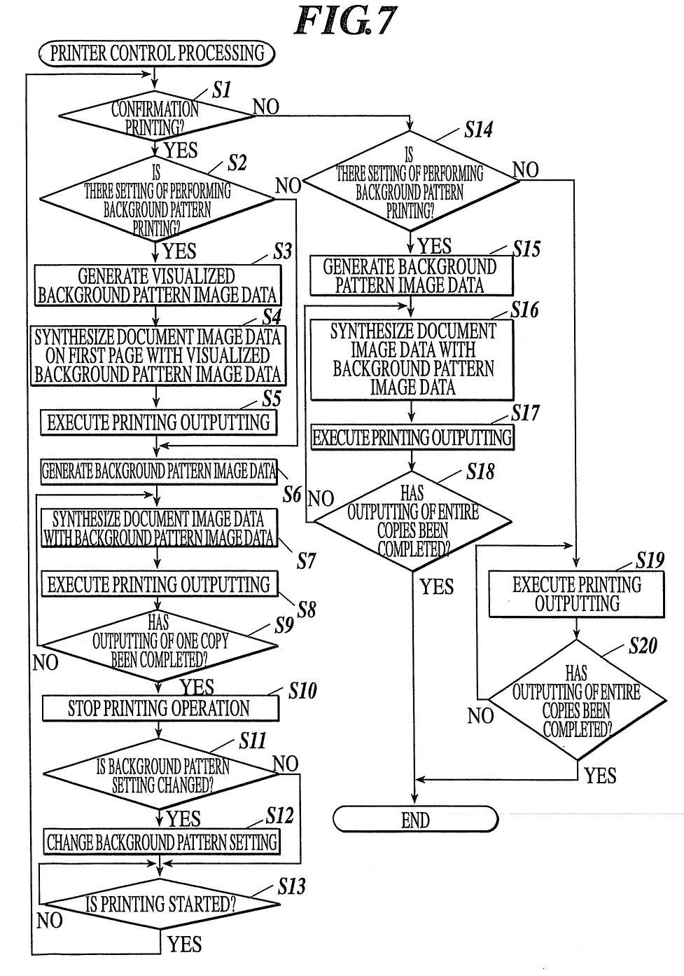

FIG. 7 shows the printing control processing executed by the control section 11. The processing is the processing to be executed when the image forming condition of a job is set from the operation screen of the operation section 20 and a confirmation printing instruction button 20b or the start button 20c is depressed to start the reading of a document image with the scanner section 30.

Incidentally, the document image signal sequentially read from the scanner section 30 is converted into Y, X, C, K image data (hereinafter referred to as document image data) by the reading processing section 13, and the document data signal is processed by the compression processing by the compression/expansion IC 15 to be stored in the compression memory 16a. The document image data corresponds to the image data of a job.

First, it is judged whether the confirmation printing instruction button 20b is depressed or the start button 20c is depressed. When it is judged that the confirmation printing instruction button 20b is depressed (Step S1), it is judged whether there is the setting of performing background pattern printing or not by referring to the set information of the job (Step S2). When it is judged that there is no setting of performing the background pattern printing (Step S2; NO), the processing moves to Step S6.

When it is judged that there is the setting of performing the background pattern printing (Step S2; YES), the latent image data corresponding to the background pattern type information and the background pattern pattern size information of the set information of the job is read from the latent image data storing section 121, and visualized background pattern image data in which the latent image is visualized, based on the read latent image data is generated (Step S3).

The generation processing of the visualized background pattern image data is, for example, performed as follows.

In the case where the background pattern type is a predetermined character string such as a typical pattern, the latent image data of the character string is read from the latent image data storing section 121, and the read latent image data is written into a region according to the printing sheet size by being repeated for the number of times for filling up the region based on the background pattern arrangement pattern information of the set information of the job. Thereby, visualized background pattern image data is generated.

Moreover, for example, in the case where the background pattern type to be used for the background pattern is a character string that is changed each time, such as a date/time and a serial number, the latent image data of the figure or the alphabet corresponding to the present date/time and a serial number to be added is sequentially read from the latent image data storing section 121, and the latent image data of a series of character strings to be written as a latent image based on the read latent image data is generated. Then, the visualized background pattern image data is generated by writing the generated latent image data into the region according to the printing sheet size by being repeated for the number of times for filling up the region, based on the background pattern arrangement pattern information of the set information of the job.

Incidentally, in the case where a plurality of background pattern types is set, a plurality of types of latent image data is written in the region according to the printing sheet size by being repeated in the order determined in the background pattern arrangement pattern information so as to fill up the region. Moreover, the density of the generated visualized background pattern image data is corrected according to the density specified by the detailed information of the background pattern. Incidentally, the density correction hereupon is the correction of the density value of a pixel when the image data is multilevel. When the image data is binary, the density correction includes, for example, the image processing of the complementation of an adjacent pixel and the addition of color data, and the density correction means the image processing for improving visibility.

When the visualized background pattern image data is generated, the document image data on the first page and the visualized background pattern image data are synthesized based on the detailed information in the case of performing the printing of the background pattern included in the set information of the job (Step S4). To put it concretely, first, the document image data of each of the colors Y, M, C, and K on the first page, which image data is stored in the compression memory 16a, is output to the compression/expansion IC 15 through the DRAM control IC 14, and is expanded therein. The expanded image data is severally expanded in the page memory 16b through the DRAM control IC 14. Next, the generated visualized background pattern image data and the document image data expanded in the page memory 16b (the page memory 16b corresponding to the color specified by the background pattern color information) are subjected to OR processing by every corresponding pixel, and the processing results are written in the page memory 16b. In the OR processing, when at least one of the two image data is 1, the value of the pixel becomes 1. Thereby, the document image data of the first page and the visualized background pattern image data are synthesized, and visualized background pattern synthesizing image data is generated.

Print output is executed based on the visualized background pattern synthesizing image data generated by synthesizing the read latent image data and the document image data on the first page, that is, the image data expanded on the page memory 16b of each color (Step S5). To put it concretely, the image data expanded on the page memory 16b of each color is converted into a PWM signal by the writing processing section 17, and visualized background pattern synthesizing image for visualizing the latent image of the document image and the background pattern is formed on a printing sheet based on the PWM signal in the printer section 50.

Next, the background pattern image data is generated based on the latent image data generated at Step S3 and the background image data (Step S6). That is, the background image data is read from the background image data storing section 122 of the nonvolatile memory 12, and OR processing of the generated latent image data and the background image data is executed to each corresponding pixel to synthesize the latent image data and the background image data.

When the background pattern image data is generated, parts of the document image data and the background pattern image data on each page are sequentially synthesized on the page memory 16b in order to generate the background pattern synthesizing image data (Step S7), and the print output of the background pattern synthesizing image data is performed (Step S8). To put it concretely, first, the image data of each of the colors Y, M, C, and K of the page, which image data is stored in the compression memory 16a, is output to the compression/expansion IC 15 through the DRAM control IC 14, and is expanded therein. The expanded image data is severally expanded in the page memory 16b through the DRAM control IC 14. Next, the generated background pattern image data and the document image data expanded in the page memory 16b (the page memory 16b corresponding to the color specified by the background pattern color information) are subjected to OR processing at each corresponding pixel, and the processing results are written in the page memory 16b. Thereby, the document image data and the background pattern image data at the page are synthesized to generate the background pattern synthesizing image data. Then, the image data expanded in the page memory 16b of each color is converted into a PWM signal by the writing processing section 17, and the background pattern synthesizing image, which is produced by the synthesizing of the document image and the background pattern image, is formed on a printing sheet in the printer section 50 based on the PWM signal.

When the print output of a part of the background pattern synthesizing image is completed (Step S9; YES), the printing operation of the printer section 50 is stopped (Step S10), and a message such as “Do you change the setting of the background pattern?”, a “Yes” button for instructing to perform the change of the setting, and a “No” button for instructing not to perform the change of the setting, are displayed on the screen of the LCD 22. When the “No” button is depressed (Step S11; NO), the processing moves to Step S13. When the “Yes” button is depressed (Step S11; YES), the background pattern detail setting screen 225 is displayed on the LCD 22, and setting changing processing for changing the set information of the set job is executed according to an input from the screen (Step S12). Then, the processing moves to Step S13.

At Step S13, the depressing of the confirmation printing instruction button 20b or the start button 20c is waited. When either the confirmation printing instruction button 20b or the start button 20c is depressed (Step S13; YES), the processing returns to Step S1.

On the other hand, at Step S1, when it is judged that the start button 20c is depressed (Step S1; NO), it is judged whether there is the setting of performing the background pattern printing or not by referring to the set information of the job (Step S14). When it is judged that there is the setting of performing the background pattern printing (Step S14; YES), the latent image data is read from the latent image data storing section 121 and the background image data is read from the background image data storing section 122 based on the background pattern type information and the background pattern pattern size information of the set information of the job, and the background pattern image data is generated (Step S15). The document image data and the background pattern image data in each page are sequentially synthesized (Step S16), and the print output of the synthesized data is performed by the printer section 50 (Step S17). When the print output for all the number of copies set to be output ends (Step S18), the present processing ends.

On the other hand, at Step S14, when it is judged that there is no setting of performing the background pattern printing (Step S14; NO), print output is sequentially performed by the printer section 50 based on the read document image data of each page (Step S19). When the print output for all the number of copies set to be output ends (Step S20; YES), the present processing ends.

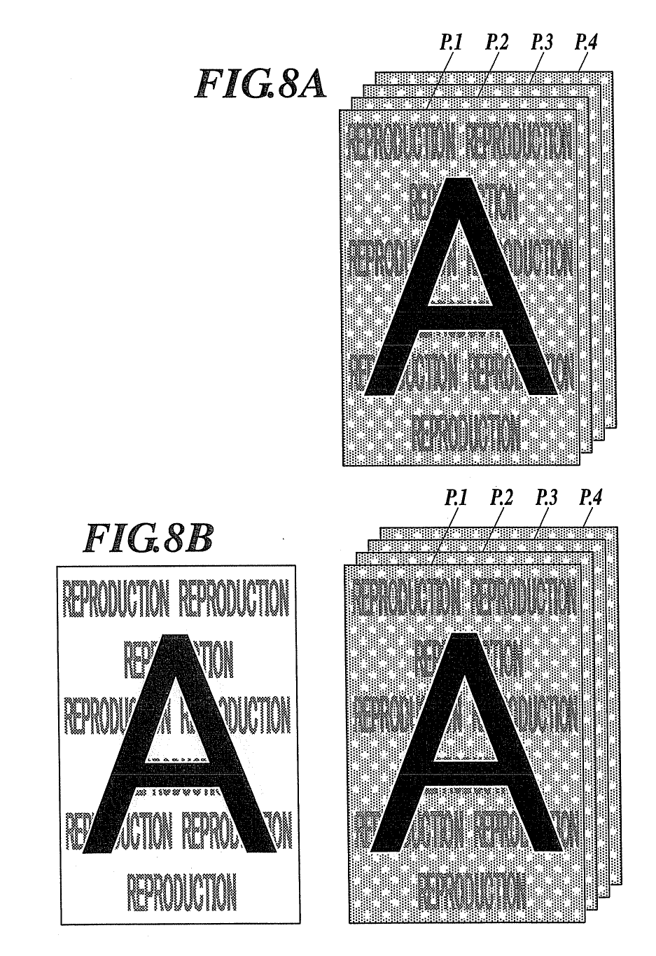

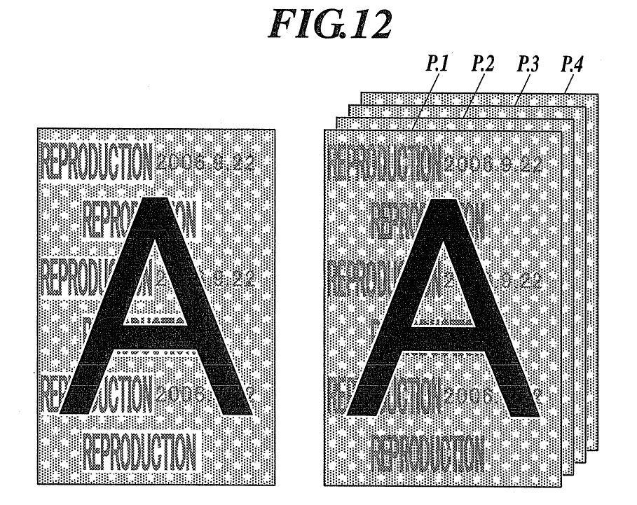

FIGS. 8A and 8B show an output example of the background pattern printing in the aforesaid printing control processing. The background pattern image of the output example is shown to be in a pixel size larger than the actual one, and is shown to be in a color of black, in order to make the description easy (the setting is also applied to FIG. 12). FIG. 8A shows an output example of the normal print to be output at the time when the setting of background pattern printing is performed and the number of copies to be output is set as one copy, and when the start button 20c is depressed to perform the printing processing of the job. FIG. 8B shows an output example of the confirmation printing to be output at the time when the setting of the background pattern printing is performed and the confirmation printing instruction button 20b is depressed to perform the printing processing. “A” is the image on the first page of the job.

As shown in FIG. 8B, when the printing processing is performed by setting the background pattern printing and by depressing the confirmation printing instruction button 20b, a part of the background pattern synthesizing image is output, and further the visualized background pattern synthesizing image in which the background pattern on the first page is visualized, is printed to be output. Consequently, the state in which the latent image of the background pattern is visualized can be printed to be output on a printing sheet together with the document image before performing the background pattern printing for a set number of copies to be output. Thus, a user can confirm whether the contents (“reproduction,” “date,” and the like), the size, the disposition, the density, and the color of the latent image to be visualized by reproducing a print printed by the background pattern printing are proper or not, or whether they are proper to the document image or not, before the outputting of the set number of copies.

Moreover, only by depressing the confirmation printing instruction button 20b, the visualized background pattern synthesizing image in which the latent image of the background pattern is visualized, is output on the first page together with a part of the background pattern synthesizing image subjected to the background pattern printing. Consequently, by one instruction operation of confirmation printing, both the result of background pattern printing and the result of the reproduction of the background pattern printed matter can easily be confirmed, and convenience is improved.

Incidentally, the aforesaid printing control processing is designed to start based on an operation from the operation section 20. However, the printing control processing may be executed at the time of the input of the image data and set information of a job through the printing controller section 60.

### Second Embodiment

In the following, a second embodiment of the present invention is described.

First, the configuration of the second embodiment is described.

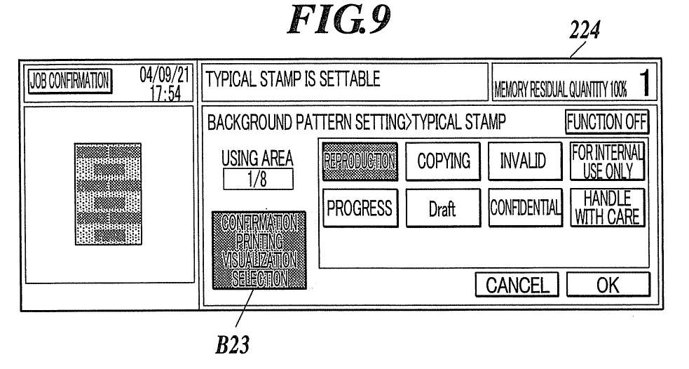

In the second embodiment, a “confirmation printing visualization selection” button B23 for instructing the selection of the background pattern type as the type of a latent image, which is visualized to be output at the time of performing confirmation printing, that is, as a selection section, is displayed in the setting screen for setting the details of the latent image of each background pattern type. The screen is displayed by the depression of the operation button for selecting a background pattern type in the background pattern type selecting screen 223, as shown in FIG. 9. When the “confirmation printing visualization selection” button B23 is depressed, the information indicating the selection of the background pattern type as the type of the latent image to be visualized and to be output, is set by the control section 11 as the confirmation printing visualization information of the background pattern type in the set information of a job.

Because the other configurations are similar to those described as for the first embodiment, their descriptions are omitted.

Next, the operation of the second embodiment is described.

In the second embodiment, the visualized background pattern image data generating processing of the second embodiment differs from that of the first embodiment. the visualized background pattern image data generating processing explained in FIG. 7 in the first embodiment is to be executed at Step S3 in the second embodiment. In the following, the visualized background pattern image data generating processing in the second embodiment is described.

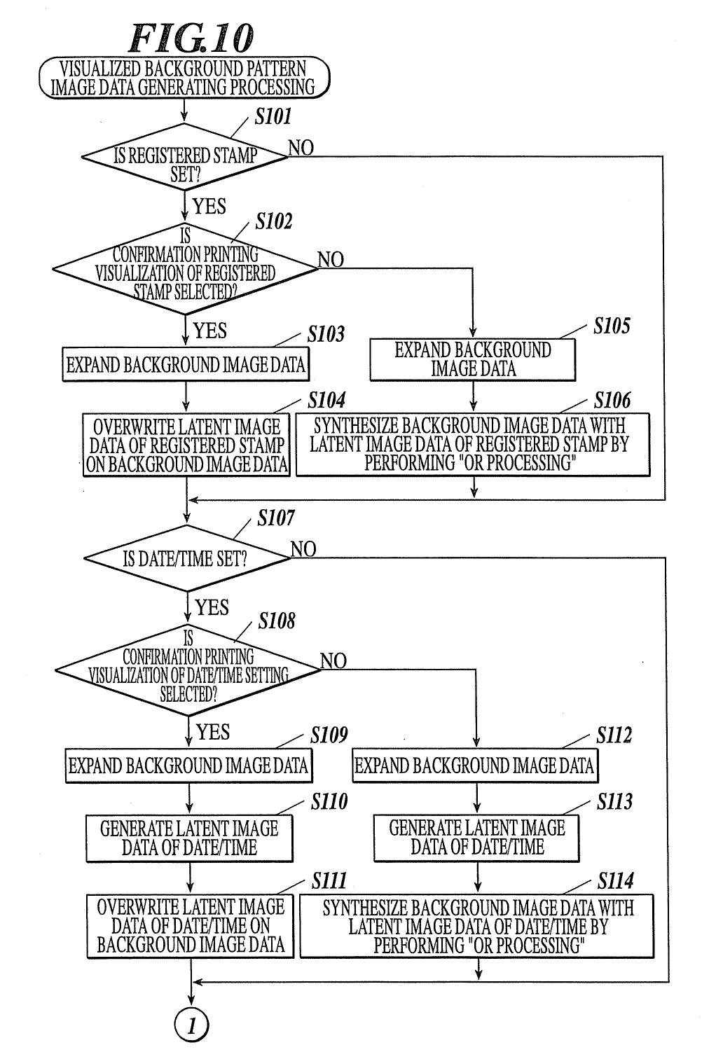

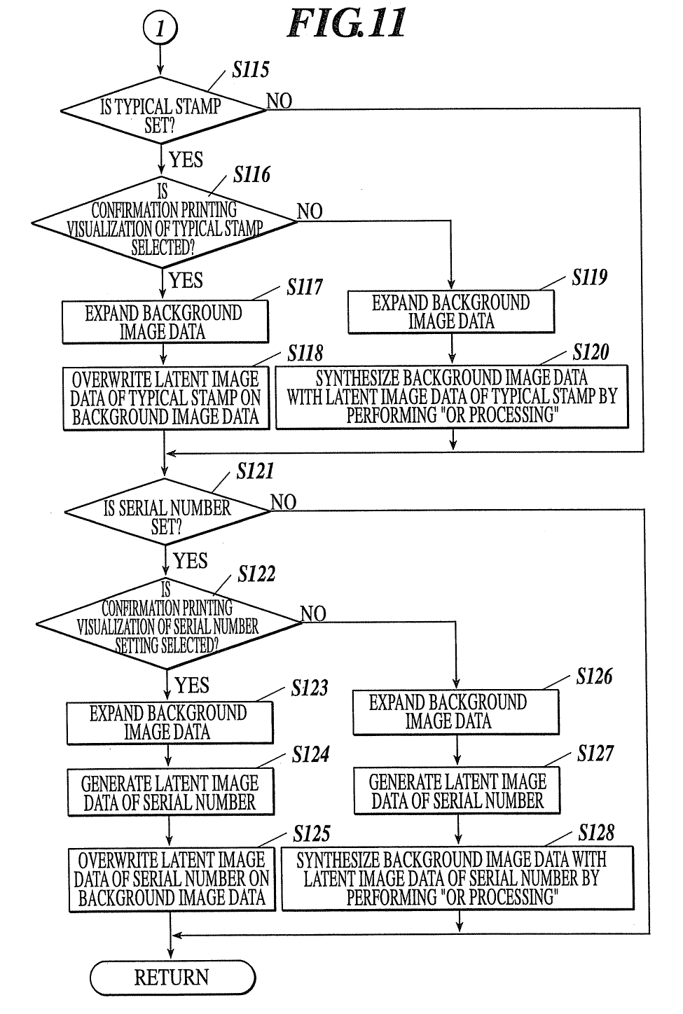

FIGS. 10 and 11 show the visualized background pattern image data generating processing to be executed by the control section 11 in the present embodiment.

First, it is judged whether the registered stamp is set as the background pattern type or not by referring to the background pattern type information of the set information of a job. When it is judged that the registered stamp is not set as the background pattern type (Step S101; NO), the processing moves to Step S107. When it is judged that the registered stamp is set as the background pattern type (Step S11; YES), it is judged whether the registered stamp is selected as the background pattern type to be visualized in the confirmation printing or not by referring to the confirmation printing visualization information of the registered stamp in the set information of the job. When it is judged that the registered stamp is selected as the background pattern type to be visualized in the confirmation printing (Step S102; YES), the background image data according to the printing sheet size is read from the background image data storing section 122 to be expanded (Step S103). Then, the latent image data of the registered stamp having the size according to the background pattern size information is read from the latent image data storing section 121. Thus the read latent image data is overwritten in the registered stamp arrangement region of the background image data specified based on the background pattern arrangement pattern information (the angle of the latent image, the arrangement interval of the latent image, the arrangement order of a plurality of background pattern types when there is a plurality of background pattern types, and the like) (Step S104). Then, the processing moves to Step S107.

On the other hand, when it is judged that the registered stamp is not selected as the background pattern type to be visualized in the confirmation printing (Step S102; NO), the background image data according to the printing sheet size is read from the background image data storing section 122, and is expanded (Step S105). Then, the latent image data of the registered stamp having the size according to the background pattern size information is read from the latent image data storing section 121. Thus the OR processing of the image data of the registered stamp arrangement region of the background image data specified based on the background pattern arrangement pattern information, and the read latent image data is performed by every corresponding pixel (Step S106). Then, the processing moves to Step S107.

At Step S107, when it is judged whether the date/time are set as the background pattern type or not by referring to the background pattern type information of the set information of the job. When it is judged that the date/time are not set as the background pattern type (Step S107; NO), the processing moves to Step S115. When it is judged that the date/time are set as the background pattern type (Step S107; YES), it is judged whether the date/time are selected as the background pattern type to be visualized in the confirmation printing by referring to the confirmation printing visualization information of the date/time of the set information of the (Step S108). When it is judged that date/time are selected as the background pattern type to be visualized in the confirmation printing (Step S108; YES), the background image data according to the printing sheet size is read from the background image data storing section 122 to be expanded (Step S109). Next, the latent image data of the figure and the like that have severally the size according to the background pattern size information and correspond to the present date/time is selected to be read from the latent image data storing section 121 in order. Thus the latent image data indicating the present date/time is generated based on the read latent image data (Step S110). Then, the read latent image data is overwritten in the date/time arrangement region of the background image data specified based on the background pattern arrangement pattern information (Step S111), and the processing moves to Step S115.

On the other hand, when it is judged that the date/time are not selected as the background pattern type to be visualized in the confirmation printing (Step S108; NO), the background image data according to the printing sheet size is read from the background image data storing section 122 to be expanded (Step S112). Next, the latent image data that has the size according to the background pattern size information and is the figure or the like corresponding to the present date/time is read from the latent image data storing section 121. Thus the latent image data indicating the present date/time is generated based on the read latent image data (Step S113). Then, the OR processing of the image data in the date/time arrangement region of the background image data specified based on the background pattern arrangement pattern information, and the read latent image data is preformed by every corresponding pixel, and both the data are synthesized (Step S114). Then, the processing moves to Step S115.

At Step S115, it is judged whether the typical stamp is set as the background pattern type or not by referring to the background pattern type information of the set information of the job. When it is judged that the typical stamp is not set as the background pattern type (Step S115; NO), the processing moves to Step S121. When it is judged that the typical stamp is set as the background pattern type (Step S115; YES), it is judged whether the typical stamp is selected as the background pattern type to be visualized in the confirmation printing or not by referring to the confirmation printing visualization information of the typical stamp of the set information of the job. When it is judged that the typical stamp is selected as the background pattern type to be visualized in the confirmation printing (Step S116; YES), the background image data according to the printing sheet size is read from the background image data storing section 122 to be expanded (Step S117). Next, the latent image data of the typical stamp having the size according to the background pattern size information is read from the latent image data storing section 121, and the read latent image data is overwritten in the typical stamp arrangement region of the background image data specified based on the background pattern arrangement pattern information (Step S118). Then, the processing moves to Step S121.

On the other hand, when it is judged that the typical stamp is not selected as the background pattern type to be visualized in the confirmation printing (Step S116; NO), the background image data according to the printing sheet size is read from the background image data storing section 122 to be expanded (Step S119). Thus the latent image data of the typical stamp having the size according to the background pattern size information is read from the latent image data storing section 121. The OR processing of the image data of the typical stamp arrangement region of the background image data specified based on the background pattern arrangement pattern information, and the read latent image data is performed by every corresponding pixel, and both the data are synthesized (Step S120). Then, the processing moves to Step S121.

At Step S121, it is judged whether the serial number is set as the background pattern type or not by referring to the background pattern type information of the set information of the job. When it is judged that the serial number is not set as the background pattern type (Step S121; NO), the processing moves to Step S4 in FIG. 7. When it is judged that the serial number is set as the background pattern type (Step S121; YES), it is judged whether the serial number is selected as the background pattern type to be visualized in the confirmation printing or not by referring to the confirmation printing visualization information of the serial number of the set information of the job. When it is judged that the serial number is selected as the background pattern type to be visualized in the confirmation printing (Step S122; YES), the background image data according to the printing sheet size is read from the background image data storing section 122 to be expanded (Step S123). Next, the latent image data that has the size according to the background pattern size information and is the figure or the like corresponding to the number to be added is sequentially selected from the latent image data storing section 121 to be read. Thus the latent image data indicating the number to be added is generated based on the read latent image data (Step S124). Then, the read latent image data is overwritten in the serial number arrangement region of the background image data specified based on the background pattern arrangement pattern information (Step S125), and the processing moves to Step S4 in FIG. 7.

On the other hand, when it is judged that the typical stamp is not selected as the background pattern type to be visualized in the confirmation printing (Step S122; NO), the background image data according to the printing sheet size is read from the background image data storing section 122 to be expanded (Step S126). Next, the latent image data that has the size according to the background pattern size information and is the figure or the like corresponding to the number to be added is sequentially selected from the latent image data storing section 121 to be read. Thus the latent image data indicating the number to be added is generated based on the read latent image data (Step S127). Then, the OR processing of the image data in the date/time arrangement region of the background image data specified based on the background pattern arrangement pattern information, and the read latent image data is performed by every corresponding pixel, and both the data are synthesized (Step S128). Then, the processing moves to Step S4 in FIG. 7.

By the aforesaid visualized background pattern image data generating processing, it is possible to generate the visualized background pattern image data of visualizing only the latent image of the background pattern type the visualization in the confirmation printing of which is selected in advance. The generated visualized background pattern image data is synthesized with the document image data as described in FIG. 7, and the print output of the synthesized image data is performed from the printer section 50. Incidentally, the density of the generated visualized background pattern image data is corrected to the density specified by the detailed information of the background pattern.

FIG. 12 shows an output example of the confirmation printing to be output at the time of performing the setting of the background pattern printing, and depressing the confirmation printing instruction button 20b to perform the printing processing in the second embodiment. FIG. 12 shows the output example when a typical stamp and a date are set as the background pattern types and the visualization in the confirmation printing is set only to the typical stamp.

As shown in FIG. 12, when the background pattern printing is set and the confirmation printing instruction button 20b is depressed to perform the printing processing, a copy of the background pattern synthesizing image is output for confirmation. Further, the print output of the visualized background pattern synthesizing image in which only the latent image of the type the visualization in the confirmation printing of which is selected in advance is visualized among the latent images of the background pattern on the first page is performed. Consequently, the state in which the latent image of the background pattern type desired by a user is visualized together with document image can be printed on a printing sheet to be output before performing the background pattern printing for the set number of copies to be output. Thus the user can confirm whether the contents (“reproduction,” “date,” and the like), the size, the arrangement, the density, and the color of the latent image to be visualized by reproducing the print subjected to the background pattern printing are proper or not, or whether they are proper to the document image or not, as for the background pattern type desired to be confirmed. For example, it is convenient to confirm whether the contents are the ones that the user intended or not when a registered stamp or a typical stamp is used.

In the above, the first and second embodiments have been described. The description contents of the aforesaid embodiments are only the preferable examples of the image forming apparatus 100 according to the present invention, and the present invention is not limited to the description contents.

For example, the first and second embodiments have been described to perform the print output for all the number of copies of the set ones when the start button 20c is depressed. However, the number of the prints to be output may be the one subtracted by 1 from the set number of copies when the start button 20c is depressed at Step S13 in FIG. 7 after a confirmation printing operation.

Moreover, the first and second embodiments have been described by exemplifying the case of forming a visualized background pattern synthesizing image produced by the synthesizing of the image data on the first page of the job and the visualized background pattern image data when the confirmation printing instruction button 20b is depressed on a printing sheet. However, it is sufficient to be able to form a visualized background pattern synthesizing image produced by the synthesizing of the image data on at least one page of the job and the visualized background pattern image data, and the page and the number of pages of the image data to be used for the formation of the visualized background pattern synthesizing image are not limited to those described in the embodiments.

Besides, also as for the detailed configurations and the detailed operations of each of the devices constituting the image forming apparatus 100, they can suitably be changed without departing from the spirit and the scope of the present invention.

The entire disclosure of Japanese Patent Application No. 2007-017838 filed on Jan. 29, 2007 including description, claims, drawings, and abstract are incorporated herein by reference in its entirety.

What is claimed is:

1. An image forming apparatus for forming an image on a printing sheet, comprising:
a printer section for forming the image on the printing sheet; and
a control section for generating a background pattern synthesizing image data by synthesizing a background pattern image data and an image data of each page of a job, and for controlling the printer section to form a background pattern synthesizing image based on the background pattern synthesizing image data, wherein
the control section generates a visualized background pattern image data based on the background pattern image data, synthesizes the generated visualized background pattern image data and at least one of the image data of the job to generate a visualized background pattern synthesizing image data, and forms a visualized background pattern synthesizing image in which a background pattern is visualized, in the printer section based on the visualized background pattern synthesizing image data.

2. The image forming apparatus of claim 1, further comprising:
an instruction section for instructing an output of a confirmation printing, wherein
when the output of the confirmation printing is instructed by the instruction section, the control section generates the visualized background pattern synthesizing image data by synthesizing the image data of a first page of the job and the visualized background pattern image data, and forms the visualized background pattern synthesizing image of the first page, in which the background pattern image is visualized, in the printer section based on the visualized background pattern synthesizing image data.

3. The image forming apparatus of claim 2, wherein
the control section synthesizes the image data of each of all pages of the job and the background pattern image data to generate the background pattern synthesizing image data, and forms a copy of the background pattern synthesizing image, in the printer section based on the background pattern synthesizing image data.

4. The image forming apparatus of claim 1, further comprising:
a selection section for selecting and inputting the background pattern image data to be visualized among a plurality of types of the background pattern image data set in advance, wherein
the control section generates the visualized background pattern image data which is visualized based on the background pattern image data selected by the selection section, synthesizes the generated visualized background pattern image data and at least one of the image data of the job to generate the visualized background pattern synthesizing image data, and forms the visualized background pattern synthesizing image, in the printer section based on the visualized background pattern synthesizing image data.

5. The image forming apparatus of claim 1, wherein
the background pattern image data includes a latent image data and a background image data, and
the control section forms the visualized background pattern synthesizing image in which a latent image is visualized, in the printer section by making the visualized background pattern image data have only the latent image data.
